(19) United States
(12) Patent Application Publication
(10) Pub. No.: US 2013/0100364 A1
(43) Pub. Date: Apr. 25, 2013

(54) LIQUID CRYSTAL DISPLAY APPARATUS AND SYSTEM

(71) Applicants: Chia-chiang Hsiao, Shenzhen (CN); Chih-Wen Chen, Shenzhen (CN); Chengming He, Shenzhen (CN)

(72) Inventors: Chia-chiang Hsiao, Shenzhen (CN); Chih-Wen Chen, Shenzhen (CN); Chengming He, Shenzhen (CN)

(73) Assignee: SHENZHEN CHINA STAR OPTOELECRTRONICS TECHNOLOGY CO.,LTD., Shenzhen (CN)

(21) Appl. No.: 13/378,039

(22) PCT Filed: Nov. 15, 2011
(86) PCT No.: PCT/CN2011/082191

§ 371 Date: Dec. 13, 2011

(30) Foreign Application Priority Data
Oct. 25, 2011 (CN) 201110327203.8

(51) Int. Cl. G02F 1/1335

(52) U.S. Cl. 349/15

(57) ABSTRACT

Disclosed is a liquid crystal display apparatus, which includes a liquid crystal display device and a liquid crystal lens. The liquid crystal lens includes a first glass substrate and a second glass substrate, and a liquid crystal layer is disposed between the first glass substrate and the second substrate. A plurality of first strip-shaped electrodes is disposed on an inner surface of the first glass substrate along a first direction. A plurality of second strip-shaped electrodes is disposed on an inner surface of the second glass substrate along a second direction. The first direction is perpendicular to the second direction. A plurality of overlapping areas is formed by the first strip-shaped electrodes and the second strip-shaped electrodes. The overlapping areas corresponding to pixels of the liquid crystal display device are utilized for implementing two-dimensional display or three-dimensional display according to voltages of the first strip-shaped electrodes and the second strip-shaped electrodes corresponding to the overlapping areas. The present invention further discloses a liquid crystal display system.

### BACKGROUND OF THE INVENTION

1. Field of the Invention

The present invention generally relates to a liquid crystal display technology field, and more particularly to a liquid crystal display apparatus and a system.

2. Description of Prior Art

With the progressive development of liquid crystal display technology, user requirements for functions of a liquid crystal display apparatus are getting higher and higher.

Take a gradient refractive index lens of the liquid crystal display apparatus for example, since the gradient refractive index lens is capable of displaying three-dimensional images, it is applied to the liquid crystal display apparatus more and more.

Please refer to FIGS. 1A-1B, FIG. 1A is a cross-sectional view of the gradient refractive index lens in the prior arts. Indium-tin oxide (ITO) electrodes 13 are disposed on a whole inner surface of an upper glass substrate 11, while patterned ITO strip-shaped electrodes are disposed on an inner surface of a lower glass substrate 12. A liquid crystal layer 15 is disposed between the upper glass substrate 11 and the lower glass substrate 12.

When no voltage is applied between the ITO electrodes 13 and the ITO strip-shaped electrodes 14, liquid crystal molecules of the liquid crystal layer 15 are horizontally arranged. When a voltage is applied between the ITO electrodes 13 and the ITO strip-shaped electrodes 14, the horizontally arranged liquid crystal molecules of the liquid crystal layer 15 in FIG. 1A are changed to an arrangement manner as shown in FIG. 1B. In FIG. 1B, the liquid crystal molecules near the ITO strip-shaped electrodes 14 still remain horizontal. When light is vertically incident to the lower glass substrate 12, the refractive index of the liquid crystal molecules, which are met by the light, is a refractive index no in a short-axis direction of liquid crystal. The liquid crystal molecules near the ITO electrode 13 are changed to be arranged vertically because of a difference of the voltage. Therefore, the refractive index of the liquid crystal molecules, which are met by the light, is a refractive index ne in a long-axis direction of liquid crystal. The refractive index of the liquid crystal molecules, which are met by the light and between the ITO electrodes 13 and the ITO strip-shaped electrodes 14, is a gradient change between ne and no because the liquid crystal molecules are tilted.

Apparently, the arrangement direction of the liquid crystal molecules of the liquid crystal layer 15 can be controlled by controlling the voltages of the ITO electrodes 13 and the ITO strip-shaped electrodes 14, such that the arrangement of the liquid crystal molecules is a gradient change and thus the refractive index of the liquid crystal layer 15 is parabolically distributed for implementing three-dimensional display.

However, the gradient refractive index lens in the prior arts can display only one of two-dimensional images and three-dimensional images wholly. When the two-dimensional images and the three-dimensional images are required to be switched by the liquid crystal display apparatus in the prior arts, the only method for implementing the three-dimensional display is by controlling the whole gradient refractive index lens to form the convex or concave effect but the method has disadvantages of low efficiency and high electrical energy consumption.

### SUMMARY OF THE INVENTION

An objective of the present invention is to provide a liquid crystal display apparatus to solve the technical problem that when the two-dimensional images and the three-dimensional images are required to be switched by the liquid crystal display apparatus in the prior arts, the only method for implementing the three-dimensional display is by controlling the whole gradient refractive index lens to form the convex or concave effect but the method has disadvantages of low efficiency and high electrical energy consumption.

To solve the above-mentioned problem, the present invention provides a liquid crystal display apparatus, which comprises a liquid crystal display device. The apparatus further comprises a liquid crystal lens. The liquid crystal lens extends along a horizontal surface. The liquid crystal lens is connected with the liquid crystal display device.

The liquid crystal lens comprises a first glass substrate and a second glass substrate, and a liquid crystal layer is disposed between the first glass substrate and the second substrate.

A plurality of first strip-shaped electrodes is disposed on an inner surface of the first glass substrate along a first direction; a plurality of second strip-shaped electrodes is disposed on an inner surface of the second glass substrate along a second direction.

Both the first direction and the second direction are parallel with the horizontal surface, and the first direction is perpendicular to the second direction.

A plurality of overlapping areas is formed by the first strip-shaped electrodes and the second strip-shaped electrodes. The overlapping areas corresponding to pixels of the liquid crystal display device display implement three-dimensional display when the first strip-shaped electrodes and the second strip-shaped electrodes corresponding to the overlapping areas have opposite polarities and a voltage difference between the first strip-shaped electrodes and the second strip-shaped electrodes is greater than a liquid crystal saturation voltage of liquid crystal molecules of the liquid crystal layer.

The overlapping areas corresponding to the pixels of the liquid crystal display device implement two-dimensional display when the first strip-shaped electrodes and the second strip-shaped electrodes corresponding to the overlapping areas have same polarity.

In the liquid crystal display apparatus of the present invention, the overlapping areas corresponding to the pixels of the liquid crystal display device implement the two-dimensional display when the voltage difference between the first strip-shaped electrodes and the second strip-shaped electrodes corresponding to the overlapping areas is less than a liquid crystal threshold voltage of the liquid crystal molecules of the liquid crystal layer.

In the liquid crystal display apparatus of the present invention, the liquid crystal lens is connected with the liquid crystal display device by adhering together.

Another objective of the present invention is to provide a liquid crystal display apparatus to solve the technical problem that when the two-dimensional images and the three-dimensional images are required to be switched by the liquid crystal display apparatus in the prior arts, the only method for implementing the three-dimensional display is by controlling the whole gradient refractive index lens to form the convex or concave effect but the method has disadvantages of low efficiency and high electrical energy consumption.

To solve the above-mentioned problem, the present invention provides a liquid crystal display apparatus, which comprises a liquid crystal display device. The apparatus further comprises a liquid crystal lens. The liquid crystal lens extends along a horizontal surface. The liquid crystal lens is connected with the liquid crystal display device.

The liquid crystal lens comprises a first glass substrate and a second glass substrate, and a liquid crystal layer is disposed between the first glass substrate and the second substrate.

A plurality of first strip-shaped electrodes is disposed on an inner surface of the first glass substrate along a first direction; a plurality of second strip-shaped electrodes is disposed on an inner surface of the second glass substrate along a second direction.

Both the first direction and the second direction are parallel with the horizontal surface, and the first direction is perpendicular to the second direction.

A plurality of overlapping areas is formed by the first strip-shaped electrodes and the second strip-shaped electrodes, and the overlapping areas corresponding to pixels of the liquid crystal display device are utilized for implementing two-dimensional display or three-dimensional display according to voltages of the first strip-shaped electrodes and the second strip-shaped electrodes corresponding to the overlapping areas.

In the liquid crystal display apparatus of the present invention, the overlapping areas corresponding to the pixels of the liquid crystal display device implement the three-dimensional display when the first strip-shaped electrodes and the second strip-shaped electrodes corresponding to the overlapping areas have opposite polarities and a voltage difference between the first strip-shaped electrodes and the second strip-shaped electrodes is greater than a liquid crystal saturation voltage of liquid crystal molecules of the liquid crystal layer.

In the liquid crystal display apparatus of the present invention, the overlapping areas corresponding to the pixels of the liquid crystal display device implement the two-dimensional display when the first strip-shaped electrodes and the second strip-shaped electrodes corresponding to the overlapping areas have same polarity.

In the liquid crystal display apparatus of the present invention, the overlapping areas corresponding to the pixels of the liquid crystal display device implement the two-dimensional display when the voltage difference between the first strip-shaped electrodes and the second strip-shaped electrodes corresponding to the overlapping areas is less than a liquid crystal threshold voltage of the liquid crystal molecules of the liquid crystal layer.

In the liquid crystal display apparatus of the present invention, the liquid crystal lens is connected with the liquid crystal display device by adhering together.

Another objective of the present invention is to provide a liquid crystal display system to solve the technical problem that when the two-dimensional images and the three-dimensional images are required to be switched by the liquid crystal display apparatus in the prior arts, the only method for implementing the three-dimensional display is by controlling the whole gradient refractive index lens to form the convex or concave effect but the method has disadvantages of low efficiency and high electrical energy consumption.

To solve the above-mentioned problem, the present invention provides a liquid crystal display system, which comprises a liquid crystal display apparatus. The liquid crystal display apparatus comprises a liquid crystal display device. The apparatus further comprises a liquid crystal lens. The liquid crystal lens extends along a horizontal surface. The liquid crystal lens is connected with the liquid crystal display device.

The liquid crystal lens comprises a first glass substrate and a second glass substrate, and a liquid crystal layer is disposed between the first glass substrate and the second substrate.

A plurality of first strip-shaped electrodes is disposed on an inner surface of the first glass substrate along a first direction; a plurality of second strip-shaped electrodes is disposed on an inner surface of the second glass substrate along a second direction.

Both the first direction and the second direction are parallel with the horizontal surface, and the first direction is perpendicular to the second direction.

A plurality of overlapping areas is formed by the first strip-shaped electrodes and the second strip-shaped electrodes, and the overlapping areas corresponding to pixels of the liquid crystal display device are utilized for implementing two-dimensional display or three-dimensional display according to voltages of the first strip-shaped electrodes and the second strip-shaped electrodes corresponding to the overlapping areas.

In the liquid crystal display system of the present invention, the overlapping areas corresponding to the pixels of the liquid crystal display device implement the three-dimensional display when the first strip-shaped electrodes and the second strip-shaped electrodes corresponding to the overlapping areas have opposite polarities and a voltage difference between the first strip-shaped electrodes and the second strip-shaped electrodes is greater than a liquid crystal saturation voltage of liquid crystal molecules of the liquid crystal layer.

In the liquid crystal display system of the present invention, the overlapping areas corresponding to the pixels of the liquid crystal display device implement the two-dimensional display when the first strip-shaped electrodes and the second strip-shaped electrodes corresponding to the overlapping areas have same polarity.

In the liquid crystal display system of the present invention, the overlapping areas corresponding to the pixels of the liquid crystal display device implement the two-dimensional display when the voltage between the first strip-shaped electrodes and the second strip-shaped electrodes corresponding to the overlapping areas is less than a liquid crystal threshold voltage of the liquid crystal molecules of the liquid crystal layer.

In the liquid crystal display system of the present invention, the liquid crystal lens is connected with the liquid crystal display device by adhering together.

Comparing with the prior arts, the present invention solves the technical problem that when the two-dimensional images and the three-dimensional images are required to be switched by the liquid crystal display apparatus in the prior arts, the efficiency is decreased because the only method for implementing the three-dimensional display is by controlling the whole gradient refractive index lens to form the convex or concave effect. As a result, the electrical energy consumption can be decreased.

For a better understanding of the aforementioned content of the present invention, preferable embodiments are illustrated in accordance with the attached figures for further explanation:

### BRIEF DESCRIPTION OF THE DRAWINGS

FIGS. 1A-1B shows a structural diagram of gradient refractive index lens in the prior arts;

FIG. 2 shows a structural diagram of a preferable embodiment of a liquid crystal display apparatus according to the present invention;

FIG. 3 shows a top view of FIG. 2;

FIG. 4 shows an arrangement diagram of liquid crystal molecules of the liquid crystal display apparatus according to the present invention when displaying three-dimensional images;

FIG. 5 shows a visible diagram covered by a liquid crystal lens according to the present invention.

### DETAILED DESCRIPTION OF THE INVENTION

The following descriptions for the respective embodiments are specific embodiments capable of being implemented for illustrations of the present invention with referring to appended figures.

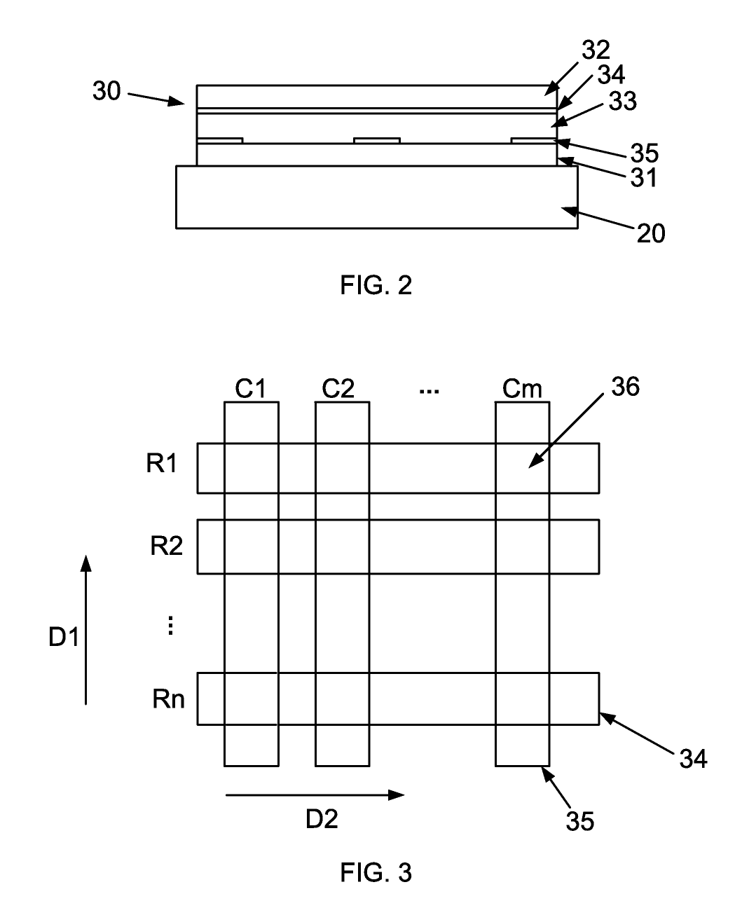

FIG. 2 is structural diagram of a preferable embodiment of a liquid crystal display apparatus according to the present invention.

The apparatus comprises a liquid crystal display device 20 and a liquid crystal lens 30. In the present embodiment, the liquid crystal lens 30 extends along a horizontal surface, and the liquid crystal lens 30 is connected with the liquid crystal display device 20. Preferredly, the liquid crystal lens 30 is connected with the liquid crystal display device 20 by adhering together, for example, by optical adhesives, ultraviolet rays (UV) adhesives. Certainly, other connection methods can also be used and are not listed in detail herein.

Preferredly, the liquid crystal lens 30 is a gradient refractive index lens. Certainly, as long as two-dimensional display and three-dimensional display over pixels of the liquid crystal display device 20 can be implemented flexibly, other types of lenses can be used and are not used in detail herein.

Please refer to FIG. 2, the liquid crystal lens 30 comprises a first glass substrate 31 and a second glass substrate 32. A liquid crystal layer 33 is disposed between the first glass substrate 31 and the second substrate 32.

Please refer to FIG. 2 with FIG. 3, a plurality of first strip-shaped electrodes 35 is disposed on an inner surface of the first glass substrate 31 along a first direction D1, while a plurality of second strip-shaped electrodes 34 is disposed on an inner surface of the second glass substrate 32 along a second direction D2.

In the present embodiment, both the first strip-shaped electrodes 35 and the second strip-shaped electrodes 34 comprise a plurality of ITO transparent conductive electrodes which are strip-shaped and parallel. Both the first strip-shaped electrodes 35 and the second strip-shaped electrodes 34 are ITO transparent conductive electrodes. Certainly, other electrode materials can also be used and are not listed in detail herein.

Both the first direction D1 and the second direction D2 are parallel with the horizontal surface, and the first direction D1 is perpendicular to the second direction D2.

Please refer to FIG. 2 with FIG. 3, a plurality of overlapping areas 36 is formed by the first strip-shaped electrodes 35 and the second strip-shaped electrodes 34. The overlapping areas 36 corresponding to the pixels are utilized for implementing the two-dimensional display or the three-dimensional display alternatively according to voltages of the first strip-shaped electrodes 35 and the second strip-shaped electrodes 34 corresponding to the overlapping areas 36. In the present embodiment, the overlapping areas 36 are corresponding to the pixels of the liquid crystal display device 20, and each of the overlapping areas 36 can be corresponding to a plurality of pixels.

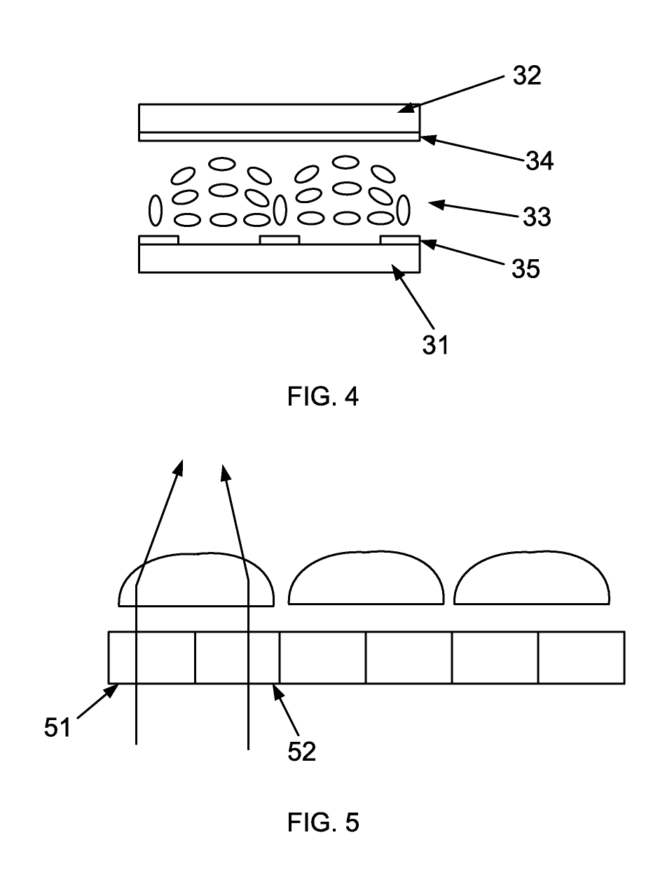

More particularly, when the voltages of the first strip-shaped electrodes 35 and the second strip-shaped electrodes 34 corresponding to the overlapping areas 36 have opposite polarities and a voltage difference between the first strip-shaped electrodes 35 and the second strip-shaped electrodes 34 is greater than a liquid crystal saturation voltage of liquid crystal molecules of the liquid crystal layer 33, the liquid crystal molecules in the overlapping areas 36 form a convex lens effect (please refer to FIG. 4), such that the overlapping areas 36 corresponding to the pixels of the liquid crystal display device 20 implement the three-dimensional display.

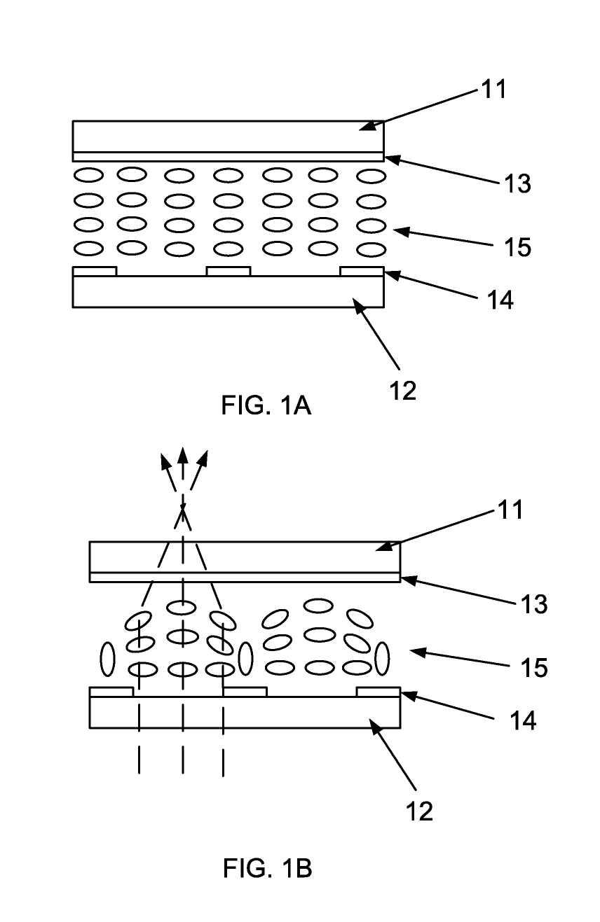

More particularly, when the voltages of the first strip-shaped electrodes 35 and the second strip-shaped electrodes 34 corresponding to the overlapping areas 36 have same polarity, the overlapping areas 36 display two-dimensional images. Alternatively, when the voltage difference between the first strip-shaped electrodes 35 and the second strip-shaped electrodes 34 corresponding to the overlapping areas 36 is less than a liquid crystal threshold voltage of the liquid crystal molecules of the liquid crystal layer 33, the liquid crystal molecules in the overlapping areas 36 does not form the convex lens effect and still remain horizontal (please refer to FIG. 1). The overlapping areas 36 corresponding to the pixels of the liquid crystal display device 20 implement the two-dimensional display.

In the present embodiment, the liquid crystal lens 30 covers at least one visible area. The visible area at least comprises a plurality of continuously adjacent pixels. Take an even number of pixels for example, two or ten pixels, referring to FIG. 5, the visible area in FIG. 5 comprises two pixels, a left-eye pixel 51 and a right-eye pixel 52.

The following is an operational principle of the preferable embodiment of the liquid crystal display apparatus according to the present invention.

All of the first strip-shaped electrodes 35 are turned on during a turn-on interval of one of the second strip-shaped electrodes 34. For example, when a positive voltage Vs is applied to a row electrode R1 of the second strip-shaped electrodes 34 and a voltages Vd or a voltage −Vd is applied to column electrodes C1˜Cm of the first strip-shaped electrodes 35, the voltage of the overlapping areas 36 includes two states.

Firstly, the voltage=Vs−(−Vd)=Vs+Vd. When Vs+Vd is greater than the liquid crystal saturation voltage of liquid crystal molecules of the liquid crystal layer 33, the liquid crystal molecules in the overlapping areas 36 are brought into a convex lens or a concave lens state (please refer to FIG. 4), such that the overlapping areas 36 corresponding to the pixels of the liquid crystal display device 20 implement the three-dimensional display.

Secondly, the voltage=Vs−Vd. When Vs−Vd is less than the liquid crystal threshold voltage of the liquid crystal molecules of the liquid crystal layer 33, the liquid crystal molecules in the overlapping areas 36 is in the horizontal state (please refer to FIG. 1), such that the overlapping areas 36 corresponding to the pixels of the liquid crystal display 20 can only implement the two-dimensional display.

For example, when the negative voltage −Vd is applied to a second column electrode C2 of the first strip-shaped electrodes 35 and the voltage Vs is applied to a row electrode R2 of the second strip-shaped electrodes 34, the voltage of the overlapping area formed by the second column electrode C2 and the second row electrode R2 is Vs+Vd, which is greater than the liquid crystal saturation voltage. The liquid crystal molecules in the overlapping area form the concave lens or convex lens state, such that the overlapping area corresponding to the pixels of the liquid crystal display device 20 implements the three-dimensional display. The voltages of other overlapping areas are +Vd or −Vd, which is less than the liquid crystal threshold voltage. The liquid crystal molecules of these overlapping areas are in the horizontal state, such that these overlapping areas corresponding to the pixels of the liquid crystal display device 20 can only implement the two-dimensional display.

The present invention controls the voltages of the first strip-shaped electrodes 35 and the second strip-shaped electrodes 34 of the liquid crystal lens 30, such that when the first strip-shaped electrodes 35 and the second strip-shaped electrodes 34 corresponding to the overlapping areas 36 have opposite polarities and the voltage difference is greater than the liquid crystal saturation voltage, the liquid crystal molecules of the overlapping areas 36 are rotated to form effect similar to the convex lens or concave lens. Accordingly, the overlapping areas 36 corresponding to the pixels of the liquid crystal display device 20 can implement the three-dimensional display. When the voltage is applied to only one of the strip-shaped electrodes 35 and the second strip-shaped electrodes 34 corresponding to the overlapping areas 36 or no voltage is applied, the liquid crystal molecules of the overlapping areas 36 are not changed to form the convex lens or concave lens effect. Accordingly, the overlapping areas 36 corresponding to the pixels of the liquid crystal display device 20 can only implement the two-dimensional display.

Apparently, the present invention can make a part of pixels of the liquid crystal display device 20 display two-dimensional images and a part of pixels display three-dimensional images.

The present invention further provides a liquid crystal display system comprising the liquid crystal display apparatus provided by the present invention. The apparatus is described in detail as mentioned above and thus not repeated herein.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A liquid crystal display apparatus, comprising a liquid crystal display device, characterized in that the apparatus further comprises a liquid crystal lens, the liquid crystal lens extends along a horizontal surface, and the liquid crystal lens is connected with the liquid crystal display device;
the liquid crystal lens comprises a first glass substrate and a second glass substrate, and a liquid crystal layer is disposed between the first glass substrate and the second substrate;
a plurality of first strip-shaped electrodes is disposed on an inner surface of the first glass substrate along a first direction; a plurality of second strip-shaped electrodes is disposed on an inner surface of the second glass substrate along a second direction;
both the first direction and the second direction are parallel with the horizontal surface, and the first direction is perpendicular to the second direction;
a plurality of overlapping areas is formed by the first strip-shaped electrodes and the second strip-shaped electrodes, the overlapping areas corresponding to pixels of the liquid crystal display device display implement three-dimensional display when the first strip-shaped electrodes and the second strip-shaped electrodes corresponding to the overlapping areas have opposite polarities and a voltage difference between the first strip-shaped electrodes and the second strip-shaped electrodes is greater than a liquid crystal saturation voltage of liquid crystal molecules of the liquid crystal layer;
the overlapping areas corresponding to the pixels of the liquid crystal display device implement two-dimensional display when the first strip-shaped electrodes and the second strip-shaped electrodes corresponding to the overlapping areas have same polarity.

2. The liquid crystal display apparatus of claim 1, characterized in that the overlapping areas corresponding to the pixels of the liquid crystal display device implement the two-dimensional display when the voltage difference between the first strip-shaped electrodes and the second strip-shaped electrodes corresponding to the overlapping areas is less than a liquid crystal threshold voltage of the liquid crystal molecules of the liquid crystal layer.

3. The liquid crystal display apparatus of claim 1, characterized in that the liquid crystal lens is connected with the liquid crystal display device by adhering together.

4. A liquid crystal display apparatus, comprising a liquid crystal display device, characterized in that the apparatus further comprises a liquid crystal lens, the liquid crystal lens extends along a horizontal surface, and the liquid crystal lens is connected with the liquid crystal display device;
the liquid crystal lens comprises a first glass substrate and a second glass substrate, and a liquid crystal layer is disposed between the first glass substrate and the second substrate;
a plurality of first strip-shaped electrodes is disposed on an inner surface of the first glass substrate along a first direction; a plurality of second strip-shaped electrodes is disposed on an inner surface of the second glass substrate along a second direction;
both the first direction and the second direction are parallel with the horizontal surface, and the first direction is perpendicular to the second direction;
a plurality of overlapping areas is formed by the first strip-shaped electrodes and the second strip-shaped electrodes, and the overlapping areas corresponding to pixels of the liquid crystal display device are utilized for implementing two-dimensional display or three-dimensional display according to voltages of the first strip-shaped electrodes and the second strip-shaped electrodes corresponding to the overlapping areas.

5. The liquid crystal display apparatus of claim 4, characterized in that the overlapping areas corresponding to the pixels of the liquid crystal display device implement the three-dimensional display when the first strip-shaped electrodes and the second strip-shaped electrodes corresponding to the overlapping areas have opposite polarities and a voltage difference between the first strip-shaped electrodes and the second strip-shaped electrodes is greater than a liquid crystal saturation voltage of liquid crystal molecules of the liquid crystal layer.

6. The liquid crystal display apparatus of claim 4, characterized in that the overlapping areas corresponding to the pixels of the liquid crystal display device implement the two-dimensional display when the first strip-shaped electrodes and the second strip-shaped electrodes corresponding to the overlapping areas have same polarity.

7. The liquid crystal display apparatus of claim 4, characterized in that the overlapping areas corresponding to the pixels of the liquid crystal display device implement the two-dimensional display when a voltage difference between the first strip-shaped electrodes and the second strip-shaped electrodes corresponding to the overlapping areas is less than a liquid crystal threshold voltage of liquid crystal molecules of the liquid crystal layer.

8. The liquid crystal display apparatus of claim 4, characterized in that the liquid crystal lens is connected with the liquid crystal display device by adhering together.

9. A liquid crystal display system, characterized in that the system comprises a liquid crystal display apparatus, the liquid crystal display apparatus comprises a liquid crystal display device, the apparatus further comprises a liquid crystal lens, the liquid crystal lens extends along a horizontal surface, and the liquid crystal lens is connected with the liquid crystal display device;
the liquid crystal lens comprises a first glass substrate and a second glass substrate, and a liquid crystal layer is disposed between the first glass substrate and the second substrate;
a plurality of first strip-shaped electrodes is disposed on an inner surface of the first glass substrate along a first direction; a plurality of second strip-shaped electrodes is disposed on an inner surface of the second glass substrate along a second direction;
both the first direction and the second direction are parallel with the horizontal surface, and the first direction is perpendicular to the second direction;
a plurality of overlapping areas is formed by the first strip-shaped electrodes and the second strip-shaped electrodes, and the overlapping areas corresponding to pixels of the liquid crystal display device are utilized for implementing two-dimensional display or three-dimensional display according to voltages of the first strip-shaped electrodes and the second strip-shaped electrodes corresponding to the overlapping areas.

10. The liquid crystal display system of claim 9, characterized in that the overlapping areas corresponding to the pixels of the liquid crystal display device implement the three-dimensional display when the first strip-shaped electrodes and the second strip-shaped electrodes corresponding to the overlapping areas have opposite polarities and a voltage difference between the first strip-shaped electrodes and the second strip-shaped electrodes is greater than a liquid crystal saturation voltage of liquid crystal molecules of the liquid crystal layer.

11. The liquid crystal display system of claim 9, characterized in that the overlapping areas corresponding to the pixels of the liquid crystal display device implement the two-dimensional display when the first strip-shaped electrodes and the second strip-shaped electrodes corresponding to the overlapping areas have same polarity.

12. The liquid crystal display system of claim 9, characterized in that the overlapping areas corresponding to the pixels of the liquid crystal display device implement the two-dimensional display when a voltage between the first strip-shaped electrodes and the second strip-shaped electrodes corresponding to the overlapping areas is less than a liquid crystal threshold voltage of liquid crystal molecules of the liquid crystal layer.

13. The liquid crystal display system of claim 9, characterized in that the liquid crystal lens is connected with the liquid crystal display device by adhering together.
